(19) United States
(12) Patent Application Publication
(10) Pub. No.: US 2026/0163019 A1
(43) Pub. Date: Jun. 11, 2026

(54) SEPARATOR PLATE ASSEMBLIES HAVING METALLIC FRAMES FOR ELECTROCHEMICAL CELLS

(71) Applicant: GM Global Technology Operations LLC, Detroit, MI (US)

(72) Inventors: Swaminatha P. Kumaraguru, Rochester Hills, MI (US); Michael Woodard, Utica, MI (US); Siguang Xu, Rochester Hills, MI (US)

(73) Assignee: GM Global Technology Operations LLC, Detroit, MI (US)

(21) Appl. No.: 18/977,181

(22) Filed: Dec. 11, 2024

(51) Int. Cl. H01M 8/0206; B60L 50/72; H01M 8/0258; H01M 8/0271; H01M 8/0656; H01M 8/10; H01M 8/1004; H01M 8/1007; H01M 8/2483

(52) U.S. Cl. CPC H01M 8/0206; B60L 50/72; H01M 8/0258; H01M 8/0271; H01M 8/0656; H01M 8/1004; H01M 8/1007; H01M 8/2483; H01M 2008/1095; H01M 2250/20

(57) ABSTRACT

A separator plate assembly for an electrochemical cell, the separator plate assembly including first and second metallic plates. The first metallic plate includes a flow field, a first periphery region, a first header opening, a first side comprising a first protrusion surrounding the first header opening and fluidly coupling the first header opening with the flow field, and a second side. The second metallic plate includes an open region corresponding to the flow field of the first metallic plate, a second periphery region, a second header opening, a first side comprising a second protrusion surrounding the second header opening and fluidly coupling the second header opening with the open region, and a second side. The second side of the second metallic plate is attached to the second side of the first metallic plate using at least one of welding, adhesive, or brazing.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

An electrochemical cell may be used as a proton-exchange membrane fuel cell (PEMFC) to produce electric power through a chemical reaction between a fuel, such as hydrogen, and an oxidant, such as oxygen. A PEMFC may be used to, for example, generate electric power for powering a vehicle from hydrogen gas. An electrochemical cell may also be used as an electrolysis cell used to split water into hydrogen and oxygen for producing low-emission hydrogen using electricity.

The present disclosure relates generally to electrochemical cells and, more particularly, to separator assemblies having metallic frames for electrochemical cells.

### SUMMARY

One aspect of the disclosure provides a vehicle including an electric motor configured to propel the vehicle, and a power system for providing electric power for powering the electric motor that includes an electrochemical cell. The electrochemical cell includes a first separator plate assembly, at least one of a porous transport layer or a gas diffusion layer, a membrane electrode assembly, a cathode insert, and a second separator plate assembly. Each separator plate assembly includes a first metallic plate and a second metallic plate. The first metallic plate includes a flow field, a first periphery region, a first header opening, a first side including a first protrusion surrounding the first header opening and fluidly coupling the first header opening with the flow field, and a second side. The second metallic plate includes an open region corresponding to the flow field of the first metallic plate, a second periphery region, a second header opening, a first side including a second protrusion surrounding the second header opening and fluidly coupling the second header opening with the open region, and a second side, wherein the second side of the second metallic plate is attached to the second side of the first metallic plate using at least one of welding, adhesive, or brazing.

Implementations of the disclosure may include one or more of the following optional features. In some implementations, the electrochemical cell is configured to generate hydrogen from water using power from a power source. Alternatively, the electrochemical cell is configured to generate the electric power from hydrogen and oxygen.

In some examples, the first protrusion and the second protrusion form a seal bead that fluidly couples the first and second header openings to the flow field and provides a sealing function. The first side of the first metallic plate may also include one or more additional protrusions, and the first side of the second metallic plate may also include one or more additional protrusions, wherein the additional protrusions of the first and second metallic plates form tunnels that fluidly couple the first and second header openings to the flow field. In some examples, the tunnels cross and are fluidly coupled to the seal bead.

In some examples, the second metallic plate is welded to the first metallic plate prior to assembling the electrochemical cell. In some implementations, the first side of the first metallic plate also includes a first perimeter seal, and the first side of the second metallic plate also includes a second perimeter seal that together with the first perimeter seal form a perimeter seal between the first and second metallic plates.

Another aspect of the disclosure provides a separator plate assembly for an electrochemical cell. The separator plate assembly including a first metallic plate and a second metallic plate. The first metallic plate includes a flow field, a first periphery region, a first header opening, a first side including a first protrusion surrounding the first header opening and fluidly coupling the first header opening with the flow field, and a second side. The second metallic plate includes an open region corresponding to the flow field of the first metallic plate, a second periphery region, a second header opening, a first side including a second protrusion surrounding the second header opening and fluidly coupling the second header opening with the open region, and a second side, wherein the second side of the second metallic plate is attached to the second side of the first metallic plate using at least one of welding, adhesive, or brazing.

Implementations of the disclosure may include one or more of the following optional features. In some implementations, the electrochemical cell is configured to generate hydrogen from water using power from a power source. Alternatively, the electrochemical cell is configured to generate the electric power from hydrogen and oxygen.

In some examples, the first protrusion and the second protrusion form a seal bead that fluidly couples the first and second header openings to the flow field and provides a sealing function. The first side of the first metallic plate may also include one or more additional protrusions, and the first side of the second metallic plate may also include one or more additional protrusions, wherein the additional protrusions of the first and second metallic plates form tunnels that fluidly couple the first and second header openings to the flow field. In some examples, the tunnels cross and are fluidly coupled to the seal bead.

In some examples, the second metallic plate is welded to the first metallic plate prior to assembling the electrochemical cell. In some implementations, the first side of the first metallic plate also includes a first perimeter seal, and the first side of the second metallic plate also includes a second perimeter seal that together with the first perimeter seal form a perimeter seal between the first and second metallic plates.

Yet another aspect of the disclosure provides an electrochemical cell that includes a first separator plate assembly, at least one of a porous transport layer or a gas diffusion layer, a membrane electrode assembly, a cathode insert, and a second separator plate assembly. Each separator plate assembly includes a first metallic plate and a second metallic plate. The first metallic plate includes a flow field, a first periphery region, a first header opening, a first side including a first protrusion surrounding the first header opening and fluidly coupling the first header opening with the flow field, and a second side. The second metallic plate includes an open region corresponding to the flow field of the first metallic plate, a second periphery region, a second header opening, a first side including a second protrusion surrounding the second header opening and fluidly coupling the second header opening with the open region, and a second side, wherein the second side of the second metallic plate is attached to the second side of the first metallic plate using at least one of welding, adhesive, or brazing.

Implementations of the disclosure may include one or more of the following optional features. In some implementations, the electrochemical cell is configured to generate hydrogen from water using power from a power source. Alternatively, the electrochemical cell is configured to generate the electric power from hydrogen and oxygen.

In some examples, the first protrusion and the second protrusion form a seal bead that fluidly couples the first and second header openings to the flow field and provides a sealing function. The first side of the first metallic plate may also include one or more additional protrusions, and the first side of the second metallic plate may also include one or more additional protrusions, wherein the additional protrusions of the first and second metallic plates form tunnels that fluidly couple the first and second header openings to the flow field. In some examples, the tunnels cross and are fluidly coupled to the seal bead.

In some examples, the second metallic plate is welded to the first metallic plate prior to assembling the electrochemical cell. In some implementations, the first side of the first metallic plate also includes a first perimeter seal, and the first side of the second metallic plate also includes a second perimeter seal that together with the first perimeter seal form a perimeter seal between the first and second metallic plates.

### BRIEF DESCRIPTION OF THE DRAWINGS

The drawings described herein are for illustrative purposes only of selected configurations and are not intended to limit the scope of the present disclosure.

FIG. 1 is a view of an example vehicle incorporating a power system having an electrolysis cell in accordance with the principles of the present disclosure.

FIG. 2 is a schematic view of the power system of FIG. 1.

FIG. 3 is an exploded view of an example electrolysis cell incorporating a separator plate assembly having metallic frames in accordance with the principles of the present disclosure.

FIG. 4 is a partially assembled exploded view of the example electrolysis cell of FIG. 3.

FIG. 5 is a side cross-sectional view of the electrolysis cell of FIG. 3 after assembly.

FIG. 6 is a top view of an example separator plate.

FIG. 7 is a top view of an example metallic frame.

FIG. 8 is zoomed-in view of a portion of the separator plate assembly of FIG. 3.

FIG. 9 is a side cross-sectional view of the separator plate assembly of FIG. 8 along line 9-9.

FIG. 10A is side cross-sectional view of an example symmetric metal bead profile.

FIG. 10B is side cross-sectional view of an example asymmetric metal bead profile.

FIG. 11 is a side cross-sectional view of the separator plate assembly of FIG. 8 along line 11-11.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

An electrochemical cell may be used as proton-exchange membrane fuel cell (PEMFC) to produce electric power through a chemical reaction between a fuel, such as hydrogen, and an oxidant, such as oxygen. A PEMFC may be used to, for example, generate electric power for powering a vehicle from hydrogen gas. An electrochemical cell may also be used as an electrolysis cell to split water into hydrogen and oxygen for producing low-emission hydrogen using electricity. Bipolar plates, or separator plates are key components of an electrochemical cell. The bipolar plates, or separator plates serve as current collectors to and from the unitized electrode assembly as well as facilitate fluid flow, heat removal etc. Bipolar plates or separator plates as they are commonly called, for electrolysis cells are typically a single separator plate with a primary anode flow field. Here, the fluid paths from headers are typically made through complex gaskets, complex plastic frames, or over-molded designs, which may lead to increased cost, complexity in unitized electrode assembly (UEA) design, limit durability, or result in potential life-limiting failure modes. Accordingly, there is a need for improved separator plates for electrolysis cells. In disclosed implementations, a metallic frame is affixed to a metallic separator plate for facilitating fluid flow from the header openings to a flow field. Here, the separator plate and frame may be stacked together with multiple and robust sealing interfaces. The metallic frame in combination with the metallic separator plate enables high-volume manufacturing seal designs. Such separator plate assemblies can also be applied to PEMFC that are air cooled or hydrogen cooled and does not require a separate coolant and coolant flow path.

While configurations are shown and described herein in connection with a vehicle (e.g., an automobile, a truck, an airplane, a train, a motorcycle, a bicycle, a drone, etc.), it should be understood that disclosed configurations may, additionally or alternatively, be used with any other type of device that may be used for, or utilize, generating hydrogen from water using electricity and/or generating electric power from hydrogen. Here, a vehicle or device may be operated by a person or may operate independently.

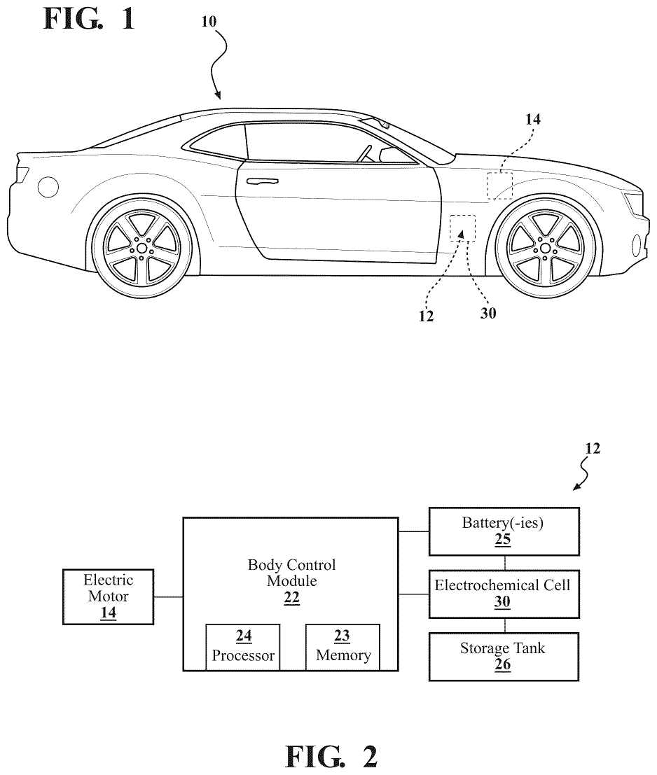

With particular reference to FIGS. 1 and 2, a vehicle 10 (e.g., an automobile, a truck, an airplane, a train, a motorcycle, a bicycle, a drone, etc.) is shown in conjunction with a power system 12 that is used for generating or providing electric power for powering an electric motor 14 that is configured to propel the vehicle 10. Here, the power system 12 includes an electrochemical cell 30 for generating hydrogen from water using electric power, or for generating electric power from hydrogen and oxygen.

A body control module (BCM) 22, or another control module, of the vehicle 10 may store machine-readable instructions for executing operations of the vehicle 10 on memory hardware 23. The instructions may be executed by data processing hardware (e.g., a processor 24) of the BCM 22 or another control module in communication with the memory hardware 23 to perform the operations. In the example, the BCM 22 is in communication with one or more batteries 25 and the electrochemical cell 30. Here, the BCM 22 may control the electrochemical cell 30 to generate electric power from hydrogen stored in a storage tank 26. The generated electric power can be stored in, or used to recharge, the battery(-ies) 25, and/or to power the electric motor 14. Additionally, or alternatively, the BCM 22 may control the electrolysis cell 30 to generate and store hydrogen in the storage tank 26 from water using electric power from the battery(-ies) 25 or any other power source.

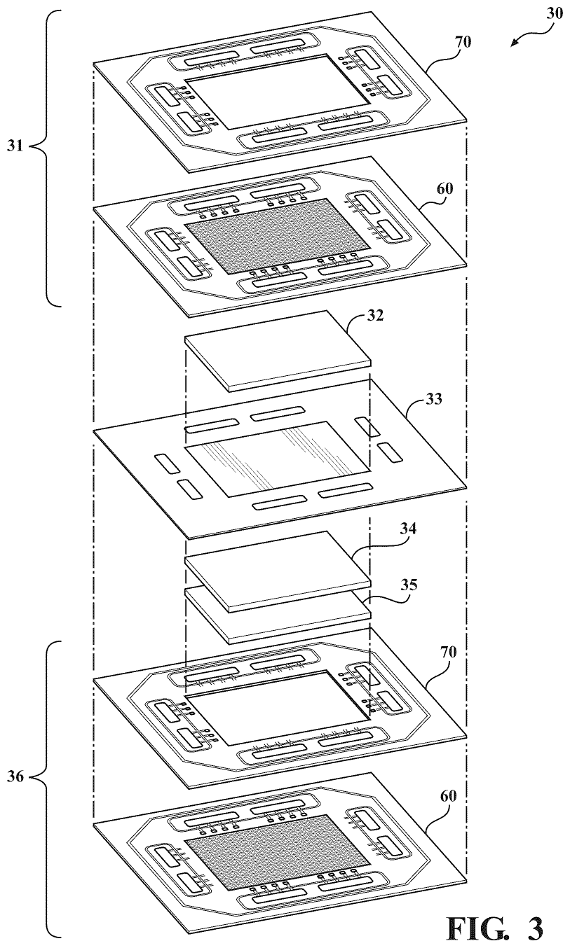

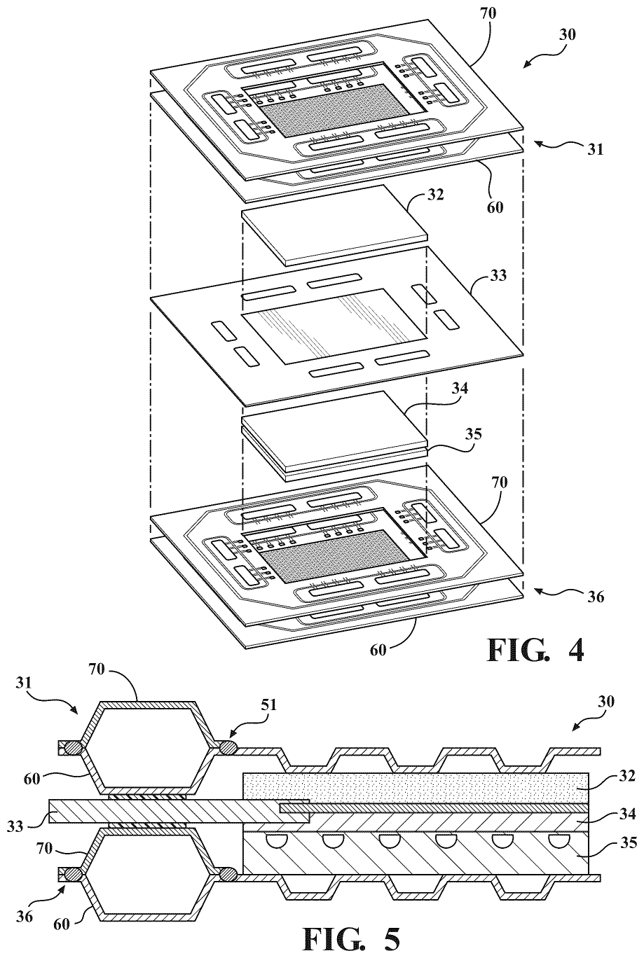

With particular reference to FIGS. 3-9, 10A, 10B, and 11, an example electrolysis cell 30 in accordance with the principles of the present disclosure is shown. The electrolysis cell 30 includes a first separator plate assembly 31, a porous transport layer 32, a gasketed membrane electrode assembly (MEA) 33, a gas diffusion layer 34, a cathode insert 35, and a second separator plate assembly 36. The cathode insert 35 includes channels to aid fluid flow. In certain configurations, the cathode insert 35 is replaced with a thicker or additional gas diffusion layer 34.

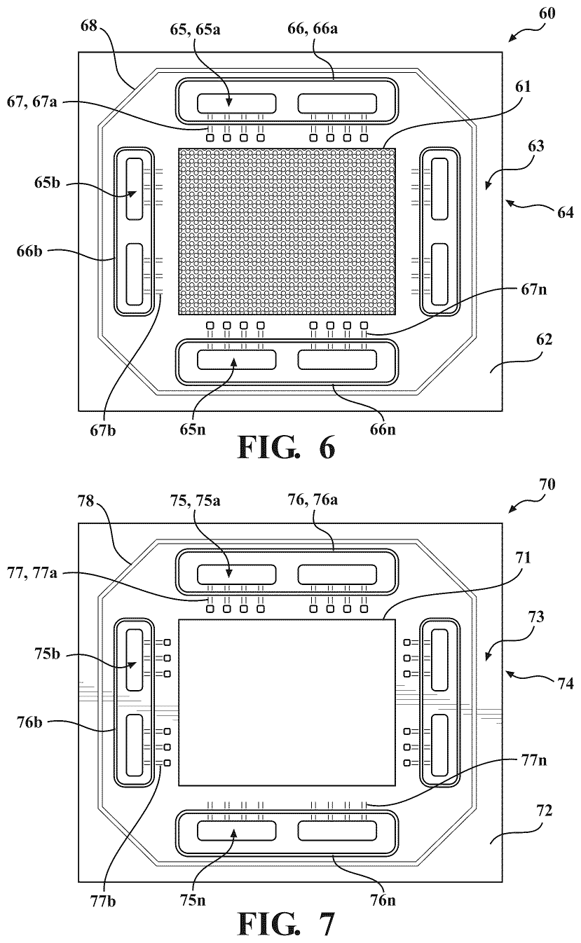

Each of the separator plate assemblies 31, 36 includes a first metallic plate 60 and a second metallic plate or frame 70. The first metallic plate 60 includes a flow field 61, a periphery region 62, a top or first side 63, and a bottom or second side 64, and one or more header openings 65, 65a-n. The top or first side 63 includes one or more protrusions 66, 66a-n surrounding the header openings 65. In the example shown, the first side 63 also includes one or more additional protrusions 67, 67a-n, and a perimeter seal 68. Here, the header openings 65 shown at the top of FIG. 6 are intake header openings, and the header openings 65 shown at the bottom of FIG. 6 are outtake header openings. As shown, a protrusion 66 may encompass one or more header openings 65. The first side 63, also includes one or more additional protrusions 68 that runs around the perimeter of the header and flow fields. The flow field 61 may include a plurality of dimple flow fields or land channels that face downward toward the porous transport layer 32. In some implementations, the first metallic plate 60 is formed of titanium. In some examples, a first metallic plate 60 that supports an anode flow may be thicker to provide higher stiffness as well as to accommodate deeper formability design requirements, such as those for dimple flow field.

The second metallic plate or frame 70 includes an open region 71, a periphery region 72, a top or first side 73, and a bottom or second side 74, and one or more header openings 75, 75a-n. The top or first side 73 includes one or more protrusions 76, 76a-n surrounding the header openings 75, and a perimeter seal 78. In the example shown, the first side 73 also includes one or more additional protrusions 77, 77a-n. Here, the header openings 75 shown at the top of FIG. 7 are intake header openings, and the header openings 75 shown at the bottom of FIG. 7 are outtake header openings. As shown, a protrusion 76 may encompass one or more header openings 75. The first side 73 also includes one or more additional protrusions 77 that run around the perimeter of the header and flow fields. In some implementations, the first metallic plate 60 is formed of titanium. The second metallic plate 70 may have the same, or a different, thickness or material as the first metallic plate 60. The perimeter seals 68, 78 may form a perimeter seal between the first and second separator plate assemblies 31, 36.

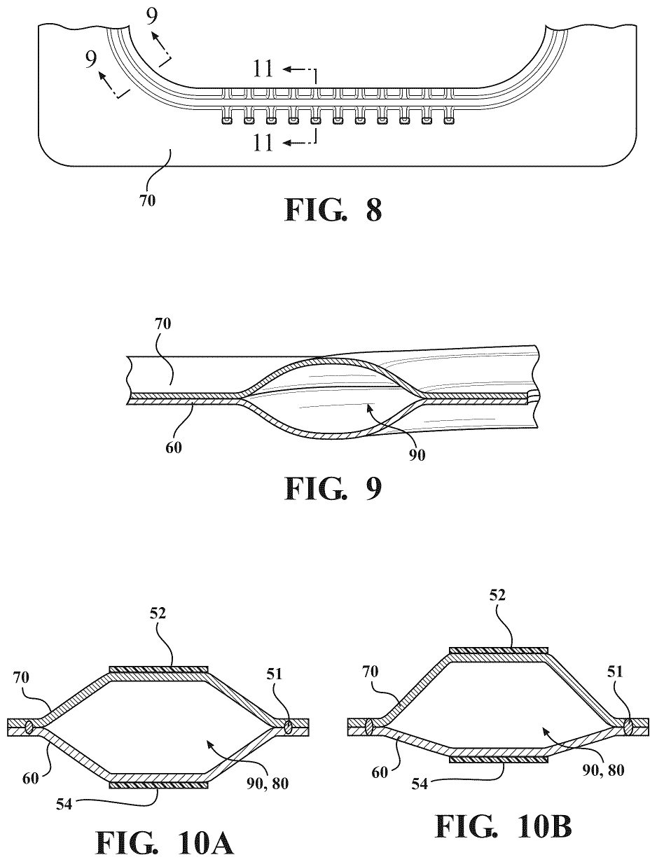

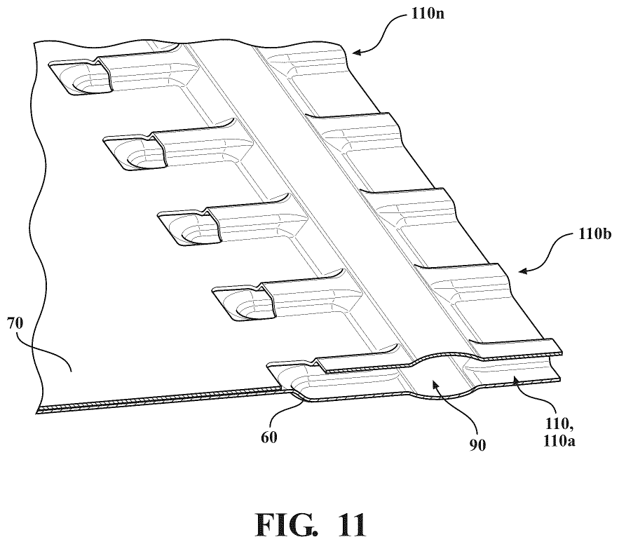

The protrusion(s) 66, 76 together with the protrusions 67, 77 fluidly couple the header openings 65, 75 with the flow field 61. Here, the protrusions 66, 76 and the protrusions 67, 77 form seal beads 90, 90a-n, a perimeter seal bead 80, and tunnels 110, 110a-n (see FIGS. 8 and 10) that fluidly couple the header openings 65, 75 with the flow field 61. Here, the tunnels 110 formed by the protrusions 67, 77 cross, or are perpendicular to, seal beads 90 formed by the protrusions 66, 76. As shown in FIGS. 9 and 10B, the seal beads 90 may be symmetrical. Alternatively, or additionally, the seal beads 90 may be asymmetrical, as shown in FIG. 10B. Additionally, a protrusion 66 and 76 may be applied with a thin elastomeric film 52, 54 to provide a unform sealing function.

Openings of the tunnels 110 are made on the corresponding metallic plate 60, 70 to provide a respective fluid flow. For example, fluids would exit the tunnels 110 to enter the flow field 61. Similarly, fluid leaving the flow field 61 will use the tunnels 110 on the outtake header openings 65 to leave the electrolysis cell 30. For example, the tunnels 110 on anode header openings 65 would have openings on the first metallic plate 60 into the anode flow field 61 facing the porous transport layer 32. This enables water flow from the anode header openings 65 into the anode flow field 61 as well as to remove water from anode flow field 61 into anode outtake header openings 65. Similarly, tunnels 110 on the cathode header openings 65 would open into the first side 73 of the second metallic plate 70.

The second side 74 of the second metallic plate 70 is attached or affixed to the second side 64 of the first metallic plate 60 using at least one of welding, adhesive, or brazing 51 (see FIG. 5). As shown, the protrusions 66 and 76 may act as seals. In some examples, the metallic plates 60 and 70 are affixed to each other before the electrolysis cell 30 is assembled to reduce the number of parts that need to be stacked when assembling the electrolysis cell 30.

In some configurations, the protrusions 66, 76 that combine to form the perimeter seal bead 90, and the protrusions 68, 78 that combine to form the perimeter seal bead 80, may be replaced by a solid elastomeric material that is dispensed or screen printed around the header. In such configurations, the protrusions 67, 77 that combine to form the tunnel 110 are continuous and an elastomeric seal may traverse over the tunnels 110. In other examples, the tunnels 110 are formed by only the protrusion 67 of the first metallic plate 60 or the protrusions 77 of the second metallic plate 70.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
an electric motor configured to propel the vehicle;
a power system for providing electric power for powering the electric motor, the power system comprising an electrochemical cell, the electrochemical cell comprising:
a first separator plate assembly;
at least one of a porous transport layer or a gas diffusion layer;
a membrane electrode assembly;
a cathode insert; and
a second separator plate assembly,
wherein each of the first and second separator plate assemblies comprises:
a first metallic plate comprising:
a flow field;
a first periphery region;
a first header opening;
a first side comprising a first protrusion surrounding the first header opening and fluidly coupling the first header opening with the flow field; and
a second side; and
a second metallic plate comprising:
an open region corresponding to the flow field of the first metallic plate;
a second periphery region;
a second header opening;
a first side comprising a second protrusion surrounding the second header opening and fluidly coupling the second header opening with the open region; and
a second side, wherein the second side of the second metallic plate is attached to the second side of the first metallic plate using at least one of welding, adhesive, or brazing.

2. The vehicle of claim 1, wherein the electrochemical cell is configured to generate hydrogen from water using power from a power source.

3. The vehicle of claim 1, wherein the electrochemical cell is configured to generate the electric power from hydrogen and oxygen.

4. The vehicle of claim 1, wherein the first protrusion and the second protrusion form a seal bead that fluidly couples the first and second header openings to the flow field and provides a sealing function.

5. The vehicle of claim 4, wherein:
the first side of the first metallic plate further comprises one or more additional protrusions;
the first side of the second metallic plate further comprises one or more additional protrusions; and
the additional protrusions of the first and second metallic plates form tunnels fluidly coupling the first and second header openings to the flow field.

6. The vehicle of claim 5, wherein the tunnels cross and are fluidly coupled to the seal bead.

7. The vehicle of claim 1, wherein the second metallic plate is welded to the first metallic plate prior to assembling the electrochemical cell.

8. The vehicle of claim 1, wherein:
the first side of the first metallic plate further comprises a first perimeter seal; and
the first side of the second metallic plate further comprises a second perimeter seal that together with the first perimeter seal form a perimeter seal between the first and second metallic plates.

9. A separator plate assembly for an electrochemical cell, the separator plate assembly comprising:
a first metallic plate comprising:
a flow field;
a first periphery region;
a first header opening;
a first side comprising a first protrusion surrounding the first header opening and fluidly coupling the first header opening with the flow field; and
a second side; and
a second metallic plate comprising:
an open region corresponding to the flow field of the first metallic plate;
a second periphery region;
a second header opening;
a first side comprising a second protrusion surrounding the second header opening and fluidly coupling the second header opening with the open region; and
a second side, wherein the second side of the second metallic plate is attached to the second side of the first metallic plate using at least one of welding, adhesive, or brazing.

10. The separator plate assembly of claim 9, wherein the first protrusion and the second protrusion form a seal bead that fluidly couples the first and second header openings to the flow field and provides a sealing function.

11. The separator plate assembly of claim 10, wherein:
the first side of the first metallic plate further comprises one or more additional protrusions;
the first side of the second metallic plate further comprises one or more additional protrusions; and
the additional protrusions of the first and second metallic plates form tunnels fluidly coupling the first and second header openings to the flow field, wherein the tunnels cross and are fluidly coupled to the seal bead.

12. The separator plate assembly of claim 9, wherein the second metallic plate is welded to the first metallic plate prior to assembling the electrochemical cell.

13. The separator plate assembly of claim 9, wherein the electrochemical cell is configured to generate hydrogen from water using power from a power source.

14. The separator plate assembly of claim 9, wherein the electrochemical cell is configured to generate electricity from hydrogen and oxygen.

15. The separator plate assembly of claim 9, wherein:
the first side of the first metallic plate further comprises a first perimeter seal; and
the first side of the second metallic plate further comprises a second perimeter seal that together with the first perimeter seal form a perimeter seal between the first and second metallic plates.

16. An electrochemical cell comprising:
a first separator plate assembly;
a porous transport layer;
a membrane electrode assembly;
a gas diffusion layer;
a cathode insert; and
a second separator plate assembly,
wherein each of the first and second separator plate assemblies comprises:
a first metallic plate comprising:
a flow field;
a first periphery region;
a first header opening;
a first side comprising a first protrusion surrounding the first header opening and fluidly coupling the first header opening with the flow field; and
a second side; and
a second metallic plate comprising:
an open region corresponding to the flow field of the first metallic plate;
a second periphery region;
a second header opening;
a first side comprising a second protrusion surrounding the second header opening and fluidly coupling the second header opening with the open region; and
a second side, wherein the second side of the second metallic plate is attached to the second side of the first metallic plate using at least one of welding, adhesive, brazing, or metal bead.

17. The electrochemical cell of claim 16, wherein the electrochemical cell is configured to at least one of generate hydrogen from water using power from a power source or generate electricity from hydrogen and oxygen.

18. The electrochemical cell of claim 16, wherein the first protrusion and the second protrusion form a seal bead that fluidly couples the first and second header openings to the flow field and provides a sealing function.

19. The electrochemical cell of claim 18, wherein:
the first side of the first metallic plate further comprises one or more additional protrusions;
the first side of the second metallic plate further comprises one or more additional protrusions; and
the additional protrusions of the first and second metallic plates form tunnels fluidly coupling the first and second header openings to the flow field, wherein the tunnels cross and are fluidly coupled to the seal bead.

20. The electrochemical cell of claim 18, wherein:
the first side of the first metallic plate further comprises a first perimeter seal; and
the first side of the second metallic plate further comprises a second perimeter seal that together with the first perimeter seal form a perimeter seal between the first and second metallic plates.
